(19) United States
(12) Patent Application Publication
(10) Pub. No.: US 2016/0217295 A1
(43) Pub. Date: Jul. 28, 2016

(54) TRUSTED FUNCTION BASED DATA ACCESS SECURITY CONTROL

(71) Applicant: HEWLETT PACKARD ENTERPRISE DEVELOPMENT LP, Houston, TX (US)

(72) Inventors: Patrick Goldsack, Bristol (GB); Marco Casassa Mont, Bristol (GB); Suksant Sae Lor, Bristol (GB); Simon Kai-Ying Shiu, Bristol (GB)

(21) Appl. No.: 14/915,971

(22) PCT Filed: Oct. 31, 2013
(86) PCT No.: PCT/US2013/067770

§ 371 Date: Mar. 2, 2016

(51) Int. Cl. G06F 21/62

(52) U.S. Cl. CPC G06F 21/6218

(57) ABSTRACT

According to an example, trusted function based data access security control may include determining a restriction set by a first entity and related to access to and/or analysis related to data under the control of the first entity. A trusted function including meta-data that describes a transformation of the data may be ascertained. A determination may be made as to whether the meta-data of the trusted function matches the restriction related to the access to and/or analysis related to the data. In response to a determination that the meta-data of the trusted function matches the restriction, the trusted function may be executed to allow controlled access to the data by a second entity. In response to a determination that the meta-data of the trusted function does not match the restriction, execution of the trusted function may be prevented to prevent access to the data by the second entity.

### BACKGROUND

Typically, data sharing is performed by a first entity (e.g., a sharer) that provides access to a second entity (e.g., a sharee) of a predetermined set of data that may be structured or unstructured. The predetermined set of data may be denoted as a data view of the entire data owned or otherwise controlled by the sharer. Thus, the sharer typically offers data views of the data to a sharee. The sharer also typically controls access to the data views, and defines access control parameters related, for example, to access control lists (ACLs) of who may access the data view, a sharee's capabilities needed for accessing the data view, whether the sharee can access all or part of the data view, etc. Based on such access control parameters, an authorized sharee may access the data view and use the data view as needed.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a trusted function based data access security control apparatus, according to an example of the present disclosure;

FIG. 2 illustrates a diagram illustrating a sharer, a sharee, and a separate trusted environment, according to an example of the present disclosure;

FIG. 3 illustrates a diagram illustrating a sharer, a sharee, and a trusted environment associated with the sharer (i.e., sharer environment is trusted), according to an example of the present disclosure;

FIG. 4 illustrates a diagram illustrating a sharer, a sharee, and a trusted environment associated with the sharee (i.e., sharee environment is trusted), according to an example of the present disclosure;

FIG. 5 illustrates a diagram illustrating a sharer, a sharee, and a trusted environment associated with the sharer and sharee (i.e., sharer and sharee environments are trusted), according to an example of the present disclosure;

FIG. 6 illustrates a method for trusted function based data access security control, according to an example of the present disclosure;

FIG. 7 illustrates further details of the method for trusted function based data access security control, according to an example of the, present disclosure; and

FIG. 8 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In an environment where two or more entities (e.g., including a sharer and a sharee) share data, the data may be located, for example, in a single repository where both entities hold their data, or in a cloud environment where the data may be distributed across the Internet. The data typically contains parts that an entity may not be permitted to have access to. For example, parts of the data may include confidential information that an entity may not be permitted to view and/or use for legal compliance purposes. The sharer, which is typically the owner of the data or an entity in charge of the data, may attempt to control a sharee's use of the data. For example, the sharer may attempt to allow or restrict access of the sharee to a data view of the data. However, once the data view is accessed by the sharee, the sharee can choose to use the data view without further control from the sharer as to how the data view is used. Access to data may also depend on what is to be done with the data, and what other data has been accessed, and may in turn restrict access to other data in the future.

According to examples, a trusted function based data access security control apparatus and a method for trusted function based data access security control are disclosed herein. The apparatus and method disclosed herein may use a trusted function to access (i.e., perform any interaction with) data in a manner permitted by restrictions set forth by the sharer. Thus, the restrictions may be used to determine what transformations of the data a sharee may have access to. The transformations of the data may encompass any specific and controlled view or analysis related to the data. The trusted function may include meta-data that describes the actions (i.e., operations) of the trusted function. Thus the meta-data may describe the types of analytic computations that are performed by the trusted function. Further, the sharer and/or sharee may understand that the meta-data of the trusted function is indeed accurate as to any actions performed by the trusted function. Further, the meta-data of the trusted function may be matched against a restriction placed by the sharer to determine what transformations of data the sharee may have access to. Thus the restriction defined by the sharer may determine what (if any) data may be accessed by the sharee. The restrictions may also be used to define other limits on access to data.

For the apparatus and method disclosed herein, the trusted function may be used as a flexible interface between two or more entities for data sharing. Thus, the apparatus and method disclosed herein generally facilitate data availability while maintaining control of what part of the data is exported, and how the exported part of the data is utilized. A sharer may effectively maintain control of the data, and allow a sharee to view and/or obtain results of an analysis related to the data (i.e., based on the transformation of data), without actually allowing the sharee to gain unauthorized access to the data that is used for the view and/or analysis. Moreover, the use of the trusted function and matching of the meta-data of the trusted function against a restriction placed by the sharer may provide confirmation to a sharer that the view and/or results of an analysis related to the data that is obtained by a sharee is limited to operations performed by an approved trusted function.

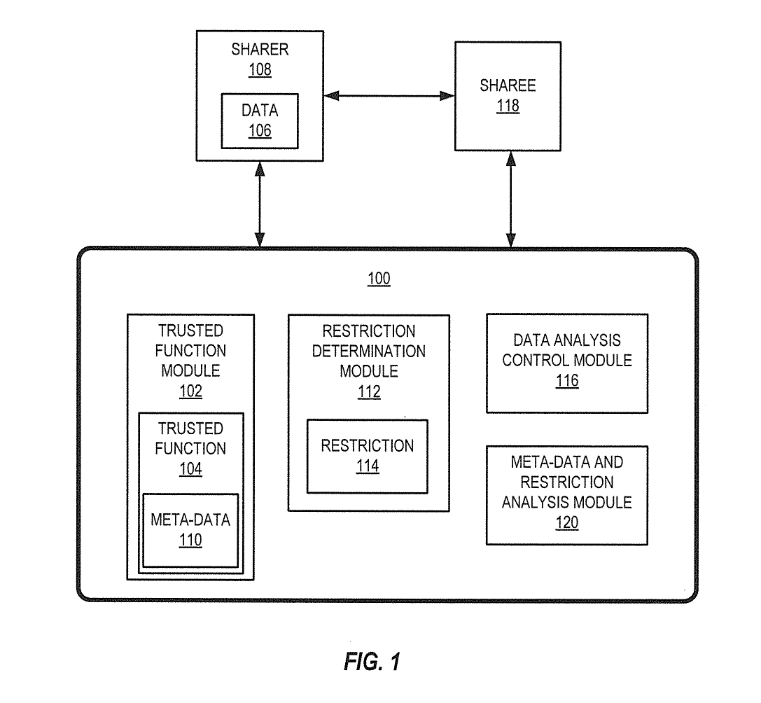

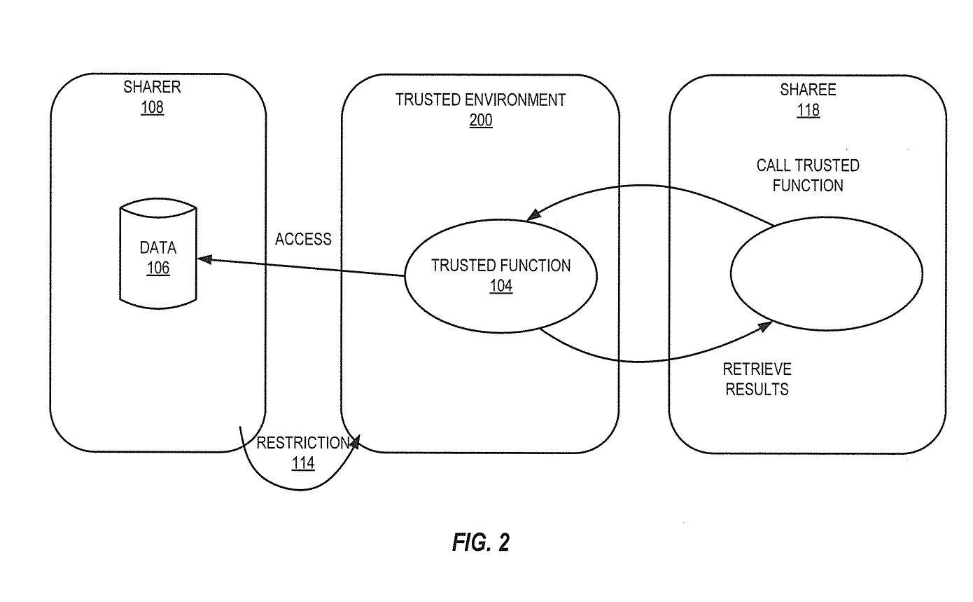

FIG. 1 illustrates an architecture of a trusted function based data access security control apparatus (hereinafter “apparatus 100”), according to an example of the present disclosure. Referring to FIG. 1, the apparatus 100 is depicted as including a trusted function module 102 to generate, determine, or receive a trusted function 104. The trusted function 104 may be used to access data 106 (or parts of the data 106) that is owned or otherwise controlled by a sharer 108. According to an example, the trusted function 104 may include a plurality of trusted functions from the sharer 108 or from a plurality of different sharers 108. The trusted function 104 may be used to access the data 106 within a trusted environment as described with reference to FIGS. 2-5. The trusted function 104 may include trusted meta-data 110 which may be used to determine how the trusted function 104 transforms the data 106.

A restriction determination module 112 may determine a restriction 114 that is set by the sharer 108, for example, related to access to and analysis of the data 106. Restrictions may take into account the identity of the sharee 118 and any properties pertaining to the sharee 118 such as location, a degree of trust associated with the device from which the sharee 118 is accessing the data 106, etc.

A data analysis control module 116 may control use of the trusted function 104 with respect to a sharee 118 of the data 106 for performing, for example, the access to and analysis of the data 106.

A meta-data and restriction analysis module 120 may determine if the meta-data 110 of the trusted function 104 matches the restriction 114 related to the access to and/or analysis related to the data 106. In response to a determination that the meta-data 110 of the trusted function 104 matches the restriction 114, the data analysis control module 116 may execute the trusted function 104 to allow controlled access to the data 106 by the sharee 118. Alternatively, in response to a determination that the meta-data 110 of the trusted function 104 does not match the restriction 114, the data analysis control module 116 may prevent execution of the trusted function 104 to prevent the access to the data 106 by the sharee 118.

As described herein, the modules and other elements of the apparatus 100 may be machine readable instructions stored on a non-transitory computer readable medium. In addition, or alternatively, the modules and other elements of the apparatus 100 may be hardware or a combination of machine readable instructions and hardware.

Referring to FIG. 1, the trusted function module 102, the restriction determination module 112, the data analysis control module 116, and the meta-data and restriction analysis module 120, according to examples thereof, are described in further detail.

Generally, the apparatus 100 may provide for sharing of the data 106 between the sharer 108 and the sharee 118 by limiting the sharee's access to the data 106 to code (i.e., machine readable instructions) for the trusted function 104 that is executed in a trusted environment. The sharer 108 and the sharee 118 may include a plurality of the sharers 108 and the sharees 114. The sharer 108 may specify the restriction 114 on the data 106 in such a way that results of the processing of the data 106 may be validated by the data analysis control module 116 against the specified restriction 114. The use of the machine readable instructions for the trusted function 104 may expand the degree of access a sharee 118 may be provided to the data 106.

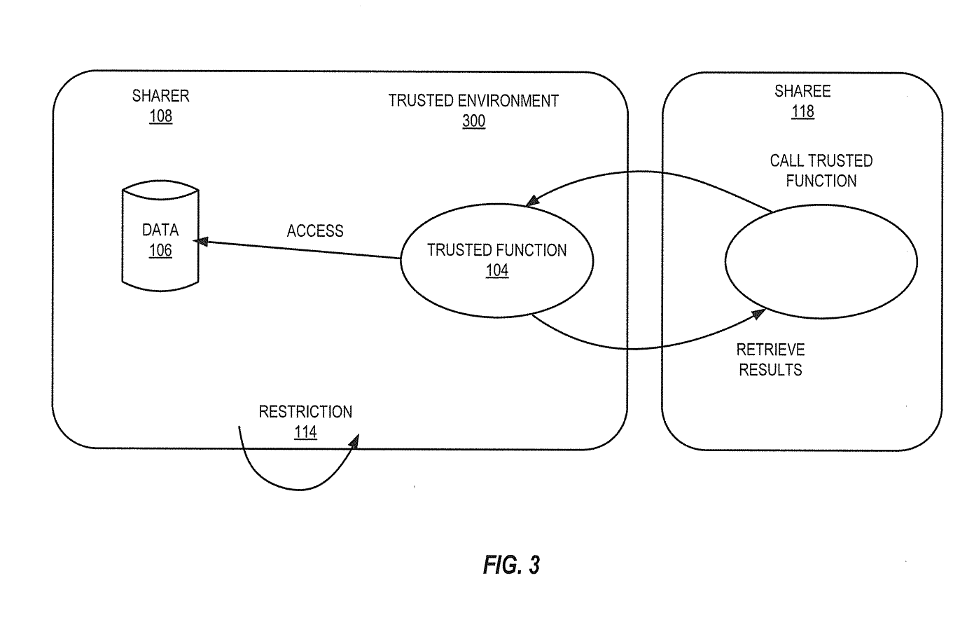

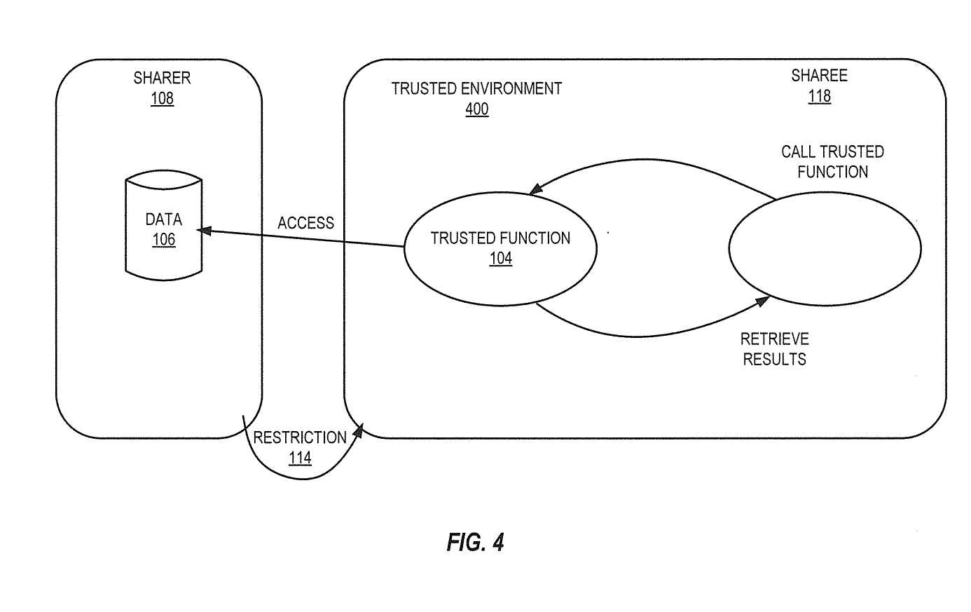

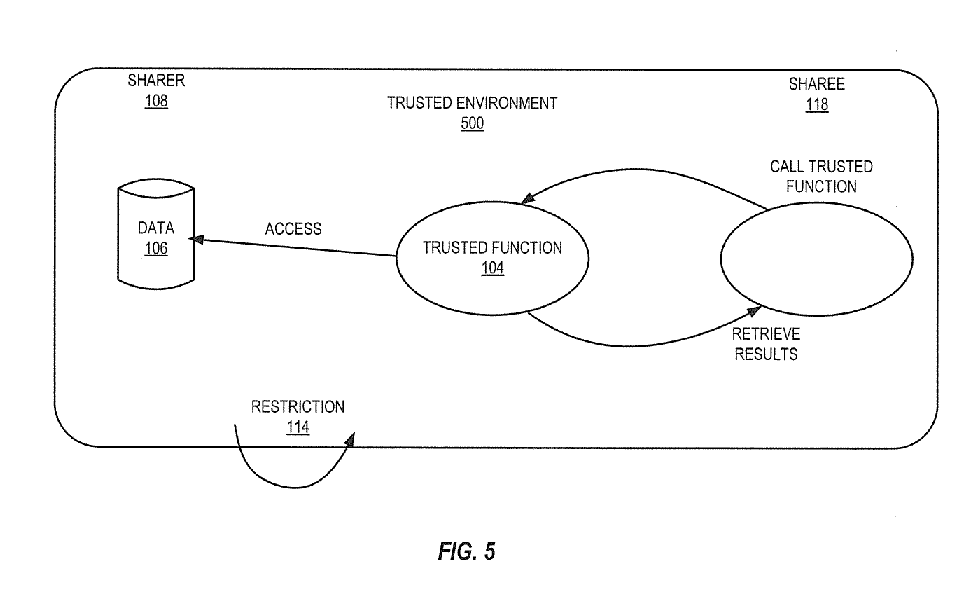

As disclosed herein, the trusted function 104 may be used to access the data 106 within a trusted environment as described with reference to FIGS. 2-5. FIG. 2 illustrates a diagram illustrating the sharer 108, the sharee 118, and a separate trusted environment 200, according to an example of the present disclosure. FIG. 3 illustrates a diagram illustrating the sharer 108, the sharee 118, and a trusted environment 300 associated with the sharer 108 (i.e., the sharer's environment is trusted), according to an example of the present disclosure. FIG. 4 illustrates a diagram illustrating the sharer 108, the sharee 118, and a trusted environment 400 associated with the sharee 118 (i.e., the sharee's environment is trusted), according to an example of the present disclosure. FIG. 5 illustrates a diagram illustrating the sharer 108, the sharee 118, and a trusted environment 500 associated with the sharer 108 and the sharee 118 (i.e., sharer and sharee environments are trusted), according to an example of the present disclosure. Therefore, as shown in FIGS. 2-5, the trusted environments 200, 300, 400, and 500 may be separate, or associated with the sharer 108, the sharee 118, or both the sharer 108 and the sharee 118.

For the example of FIG. 2, the separate trusted environment 200 may provide confirmation to the sharer 108 that any view and/or analysis related to the data 106 is performed in an environment, which is the separate trusted environment 200, which is trusted by the sharer 108 not to provide unauthorized access of the data 106 to the sharee 118. Similarly, the trusted environment 200 may provide confirmation to the sharee 118 that the results of any analysis related to the data 106 is performed in an environment, which is the separate trusted environment 200, which is trusted by the sharee 118 not to provide unauthorized access of the results of the analysis to the sharer 108. The trusted environments 300, 400, and 500 may provide similar confirmation to the sharer 108, and the sharee 118. For example, the trusted environment 300 may provide confirmation to the sharer 108 and the sharee 118 that any view and/or analysis related to the data 106 is effectively performed in the sharer's environment, and the sharee 118 receives the results of execution of the trusted function 104. Similarly, the trusted environment 400 may provide confirmation to the sharer 108 and the sharee 118 that any view and/or analysis related to the data 106 is effectively performed in the sharee's environment. Further, the trusted environment 500 may provide confirmation to the sharer 108 and the sharee 118 that any view and/or analysis related to the data 106 is performed in the sharer's and sharee's common environment.

The trusted environment may need to be trusted sufficiently by both the sharer 108 and the sharee 118. For example, the sharer 108 may need to trust the trusted environment to guarantee that the restriction 114 is applied on the data 106. Further, the sharee 118 may need to trust the trusted environment to guarantee that details related to any analysis performed by the sharee 118 are not revealed to the sharer 108. However, the sharee 118 may understand that details related to adherence to the restriction 114 may be provided to the sharer 108. The trusted environment may also be fully untrusted by either the sharer 108 or the sharee 118 if there is no restriction 114 on the data 106.

The trusted function module 102 may generate, determine, or receive the trusted function 104 to access the data 106 within the trusted environment. The trusted function module 102 may also select a trusted function from a trusted function repository. Further, the trusted function 104 may be used, for example, to transform the data 106, and/or to summarize the data 106 in a manner that is acceptable to the sharer 108. The trusted environment disclosed herein with respect to FIGS. 2-5 may have access to the trusted function 104 (e.g., from the trusted function repository). The sharer 108 or the sharee 118 may select the trusted function 104 (e.g., from the trusted function repository). Alternatively or additionally, the trusted environment disclosed herein with respect to FIGS. 2-5 may be presented with the appropriate trusted function 104 by the sharee 118 along with proof that the trusted function 104 is indeed trusted. For example, the trusted function 104 may be signed (e.g., certified) by a trusted third entity. Therefore, trust in the trusted function 104 may be achieved by either obtaining the trusted function 104 and the meta-data 110 from a trusted location, or by having the trusted function 104 and the meta-data 110 signed by a trusted party. The trusted locations may include, for example, a pre-defined library (e.g., in the trusted function module 102), or a library supplied by the sharer 108.

Examples of the data 106 and the trusted function 104 with respect to personally identifiable information (PII) filtering, obfuscation of relevant business information, statistics, and sampling, are disclosed herein.

With respect to the data 106 and the trusted function 104, according to an example, an information technology (IT) group may collect logs (e.g., the data 106) from a server and applications used with the server. This set of logs may contain the identity of all the users who have accessed the server, and the actions performed by the users. Different entities (e.g., different sharees 118) may wish to access the data 106 for different purposes. However, since the data 106 includes data that has both privacy and other analytical significance, restrictions may need to be imposed on the access to the data 106 by the sharees 118.

For the IT related example of the data 106 disclosed herein, an example of use of the data 106 by a sharee 118 may include detailed analytics, for example, to track users and derive improved navigation paths. In this case, a sharee 118 may need access to all the data 106. However, because of privacy concerns, actual user identities may need to be masked. A restriction 114, applied for the IT related example of the data 106 disclosed herein, may indicate that the trusted function 104 will apply PII filtering as described by the meta-data 110. Therefore, the trusted function 104, based on the restriction 114, may apply filters to the data 106 to ensure that the user information is obfuscated (e.g., by replacing the user information with a unique identification (ID)). The access to the data 106 may also be limited, for example, to sharees such as web designers and business analysts since the information contained in the data 106 may be of business significance.

For the IT related example of the data 106 disclosed herein, another example of use of the data 106 by a sharee 118 may include analysis of the logs (i.e., the data 106), for example, to determine the precise times (e.g., day/week/month/year) when specific services are accessed, correlations between these services, etc. In this case, access to the data 106 may be granted to a sharee 118 as long as the trusted function 104 is trusted to apply statistical functions across certain fields of the logs. The access may also be limited, for example, to sharees such as those individuals that manage servers.

For the IT related example of the data 106 disclosed herein, another example of use of the data 106 by a sharee 118 may include exploration of the patterns of access to services, failure rates, etc. In this case, although the sharee 118 (e.g., an external research group) may be performing work of interest, the sharee 118 may not be fully trusted. Thus, the sharee 118 may be granted access to the data 106 as long as the trusted function 104 can be trusted to both filter for PII, and restrict access to a statistically significant sample of the logs. This type of filtration may limit the possible leakage of business relevant data.

The trusted function 104 may include trusted meta-data 110 which may be used to determine how the trusted function 104 transforms the data 106. The meta-data 110 may include statements regarding aspects such as whether the data 106 is filtered. For example, the statements may indicate selection of specific fields (and exclusion of others) in the data 106. Alternatively or additionally, the meta-data 110 may include any sampling that may be applied to the data 106. For example, the sampling may be based on returning a random selection of 1% of the data. Alternatively or additionally, the meta-data 110 may include the production of abstractions related to the data 106. For example, the abstractions may include statistical summaries of data 106. Alternatively or additionally, the meta-data 110 may include an indication of whether the trusted function 104 is to remove PII. For example, the trusted function 104 may remove PII such as names, telephone numbers, and addresses.

The meta-data and restriction analysis module 120 may compare the meta-data 110 for the trusted function 104 to the restriction 114 specified by the sharer 108 for allowing access to the data 106. Based on a match of the meta-data 110 for the trusted function 104 to the restriction 114 (i.e., the meta-data 110 for the trusted function 104 is valid compared to the restriction 114), the trusted function 104 may be executed.

For the IT related example of the data 106 disclosed herein, the logs (i.e., the data 106) may include a list of elements which contain various fields, such as “name”. The list of elements may include an associated restriction 114 on the use of the list itself, or on all the elements of the list. According to an example, a restriction 114 may be applied to all elements and described as “obfuscateElement(name)”. The meta-data 110 associated with the trusted function 104 may be described as “obfuscateElement(name)” directly, or generally as “obfuscateElement(X)”, where “X” is a parameter to the trusted function 104. If the invocation includes “X=name”, then the data analysis control module 116 may execute the trusted function 104. Otherwise, if the invocation does not include “X=name”, then the data analysis control module 116 may prevent execution of the trusted function 104.

For the IT related example of the data 106 disclosed herein, a restriction 114 may be applied to the entire list, and described as “sampling(10)” to indicate that the allowed sampling rate should be 1 in 10 or less. The trusted function 104 may include the meta-data “sampling(100)” to indicate sampling of 1 in 100, or more generally “sampling(S)”, where S is a parameter to the trusted function 104. Further, execution of the trusted function 104 may be allowed if S is bound to a value of 10 or greater (i.e., less than one in 10).

The restriction 114 and the meta-data 110 may be combined using logical connectives, such as, for example, “and” or “not”. For the IT related example of the data 106 disclosed herein, “obfuscateElement(name) and sampling(10)” may be combined to indicate that the list should be sampled and the elements obfuscated.

The trusted function 104 may be provided, for example, as a chain (i.e., serial set) of trusted functions. Alternatively or additionally, the trusted function 104 may be provided, for example, as a programmatic combination of trusted functions. The chain and/or programmatic combination of the trusted functions may be provided by the sharer 108, the sharee 118, and/or provided in the trusted function environment and selected by the sharer 108 and/or the sharee 118. The chain and/or programmatic combination of the trusted functions may facilitate application, for example, of complex tasks that satisfy more complex restrictions. As described herein, trust in the trusted function 104 may be achieved by either obtaining the trusted function 104 and the meta-data 110 from a trusted location, or by having the trusted function 104 and the meta-data 110 signed by a trusted party. According to an example, the chain and the programmatic combination of the trusted functions may by applicable to the data 106 that the sharer 108 may share if the trusted function 104 is limited, by the restriction 114, to providing statistical summaries over a random sample of no more than 1% of the data 106. To satisfy this restriction 114, the sharee 118 may need to chain both a sampling based trusted function 104 and a statistical analysis based trusted function 104. With respect to the restriction 114 in this example, neither the sampling based trusted function 104 and nor the statistical analysis based trusted function 104 may be separately adequate to support the restriction 114. Moreover, such a combined trusted function 104 may not have been previously generated as a trusted function. Therefore, the trusted function 104 may be provided as a chain and/or programmatic combination of the trusted functions 104. The restriction 114 may also be used to prioritize trusted functions. For example, for trusted functions that are provides as a chain and/or programmatic combination of the trusted functions 104, certain components of the trusted function 104 may be performed before other components. For example, a sampler component of a combination based trusted function may be performed before an obfustactor component for improving efficiency of execution of such a combination based trusted function. In this example, the restriction 114 may be used to prioritize the sampler component of the combination based trusted function over the obfustactor component.

Thus, as disclosed herein, the trusted functions 104 may be combined (e.g. in a chain of invocations). For example the trusted functions 104 may include “computational trusted components” and “aggregation/combination trusted components”. The “aggregation/combination trusted components” may include meta-data mandating how the composition of different inputs should occur, which transformation should occur on the aggregated data, etc.

For the IT related example of the data 106 disclosed herein, if the meta-data 110 indicates “obfuscateElement(name) and sampling(10)”, the trusted function 104 may include a combination. For example, the trusted function 104 may include a sampler based trusted function 104 followed by an obfuscator based trusted function 104. For example, the trusted function 104 may include a “trusted combinator” where the result of the combination is conjunction of the list and element meta-data (e.g., “followedByMap”). In such a case, the sampler portion of the combination based trusted function 104 may produce a sampled list, and the obfustactor portion of the combination based trusted function 104 may be mapped over the result to produce an obfuscated list. In this particular example, the order of the sampler portion and the obfustactor portion of the combination based trusted function 104 may be switched. Thus, the trusted function 104 may include a “sampling function followedByMap obfuscation function”, for matching appropriate restrictions 114.

With respect to the trusted function 104 that may be provided as a chain and/or programmatic combination of the trusted functions 104, the complexity of the combinations that may be allowed may depend on the capabilities of the data analysis control module 116. Examples of complexities may include trusted functions 104 related to techniques for inspection of machine readable instructions, or data-flow analysis for arbitrary programs.

The restriction 114 may also span multiple trusted functions 104. For example, the restriction 114 may include a plurality of restrictions for a single sharee 118. The restriction 114 may also include a plurality of restrictions across multiple sharees 118. For example, the restriction 114 may ensure that a predetermined maximum overall sampling is guaranteed even while running multiple trusted functions 104. In this regard, the data analysis control module 116 may maintain a state that persists across invocations of the trusted functions 104.

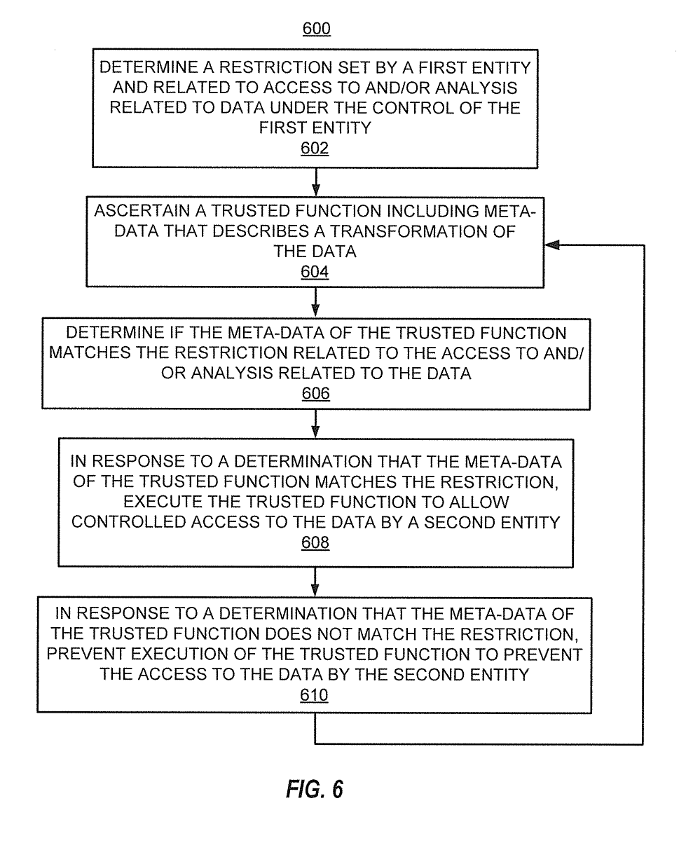

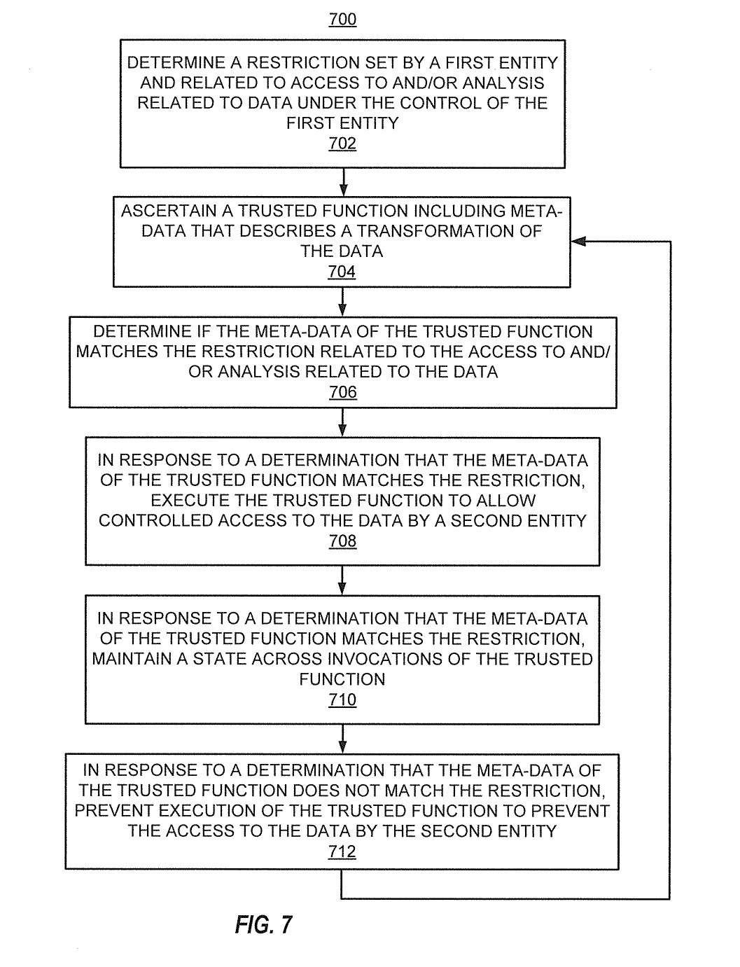

FIGS. 6 and 7 respectively illustrate flowcharts of methods 600 and 700 for trusted function based data access security control, corresponding to the example of the trusted function based data access security control apparatus 100 whose construction is described in detail above. The methods 600 and 700 may be implemented on the trusted function based data access security control apparatus 100 with reference to FIGS. 1-5 by way of example and not limitation. The methods 600 and 700 may be practiced in other apparatus.

Referring to FIG. 6, for the method 600, at block 602, the method may include determining a restriction set by a first entity and related to access to and/or analysis related to data under the control of the first entity. For example, referring to FIG. 1, the restriction determination module 112 may determine a restriction 114 that is set by a first entity (e.g., the sharer 108), for example, related to access to and/or analysis of the data 106 under the control of the sharer 108).

At block 604, the method may include ascertaining a trusted function including meta-data that describes a transformation of the data. For example, referring to FIG. 1, the trusted function module 102 may ascertain a trusted function 104 including meta-data 110 that describes a transformation of the data 106. The transformation of the data 106 may include a view of and/or analysis related to the data 106. According to an example, ascertaining a trusted function including meta-data that describes a transformation of data under the control of a first entity may further include receiving the trusted function 104 from a third entity (e.g., a trusted entity) that is trusted by the first and second entities (e.g., the sharer 108 and the sharee 118). According to an example, ascertaining a trusted function including meta-data that describes a transformation of data under the control of a first entity may further include receiving the trusted function from the first entity (e.g., the sharer 108), with the trusted function being based on the restriction 114 set by the first entity. According to an example, ascertaining a trusted function including meta-data that describes a transformation of data under the control of a first entity may further include selecting the trusted function from a set of trusted functions based on capabilities of the second entity (e.g., the sharee 118) for using the trusted function.

At block 606, the method may include determining if the meta-data of the trusted function matches the restriction related to the access to and/or analysis related to the data. For example, referring to FIG. 1, the meta-data and restriction analysis module 120 is to determine if the meta-data 110 of the trusted function 104 matches the restriction 114 related to the access to and/or analysis related to the data 106.

At block 608, in response to a determination that the meta-data of the trusted function matches the restriction, the method may include executing the trusted function to allow controlled access to the data by a second entity. For example, referring to FIG. 1, in response to a determination that the meta-data 110 of the trusted function 104 matches the restriction 114, the data analysis control module 116 may execute the trusted function 104 to allow controlled access to the data 106 by the sharee 118. According to an example, executing the trusted function to allow controlled access to the data 106 by a second entity (e.g., the sharee 118) may further include executing the trusted function 104 in a trusted environment (e.g., see the trusted environment 200 of FIG. 2) that is different from environments of the first and second entities. According to an example, executing the trusted function 104 to allow controlled access to the data 106 by a second entity may further include executing the trusted function 104 in a trusted environment that is the same as an environment of the first entity (e.g., see the trusted environment 300 of FIG. 3), the second entity (e.g., see the trusted environment 400 of FIG. 4), or both the first and second entities (e.g., see the trusted environment 500 of FIG. 5). According to an example, executing the trusted function 104 to allow controlled access to the data 106 by a second entity may further include executing the trusted function 104 to filter private information from the data 106. According to an example, executing the trusted function 104 to allow controlled access to the data 106 by a second entity may further include executing the trusted function 104 to apply statistical functions across predetermined data fields of the data 106. According to an example, executing the trusted function 104 to allow controlled access to the data 106 by a second entity may further include executing the trusted function 104 to restrict access to a statistically significant sample of the data 106. According to an example, the trusted function 104 may include a serial set of trusted functions and/or a programmatic combination of trusted functions, and the method may further include evaluating the restriction 114 to determine an execution order priority of the trusted function 104 including the serial set of trusted functions and/or the programmatic combination of trusted functions.

At block 610, in response to a determination that the meta-data of the trusted function does not match the restriction, the method may include preventing execution of the trusted function to prevent the access to the data by the second entity. For example, referring to FIG. 1, in response to a determination that the meta-data 110 of the trusted function 104 does not match the restriction 114, the data analysis control module 116 may prevent execution of the trusted function 104 to prevent the access to the data 106 by the sharee 118. From block 610, the method 600 may revert back to block 604 to ascertain another trusted function including meta-data that describes a transformation of the data.

According to an example, the method 600 may further include validating the transformation of the data against the restriction before providing results of the execution of the trusted function to the second entity. For example, referring to FIG. 1, the data analysis control module 116 may validate the transformation of the data 106 against the restriction 114 before providing results of the execution of the trusted function 104 to the second entity.

Referring to FIG. 7, for the method 700, at block 702, the method may include determining a restriction set by a first entity and related to access to and/or analysis related to data under the control of the first entity.

At block 704, the method may include ascertaining a trusted function including meta-data that describes a transformation of the data.

At block 706, the method may include determining if the meta-data of the trusted function matches the restriction related to the access to and/or analysis related to the data.

At block 708, in response to a determination that the meta-data of the trusted function matches the restriction, the method may include executing the trusted function to allow controlled access to the data by a second entity.

At block 710, in response to a determination that the meta-data of the trusted function matches the restriction, the method may include maintaining a state across invocations of the trusted function. For example, referring to FIG. 1, the data analysis control module 116 may maintain a state across invocations of the trusted function 104.

At block 712, in response to a determination that the meta-data of the trusted function does not match the restriction, the method may include preventing execution of the trusted function to prevent the access to the data by the second entity. From block 712, the method 700 may revert back to block 704 to ascertain another trusted function including meta-data that describes a transformation of the data.

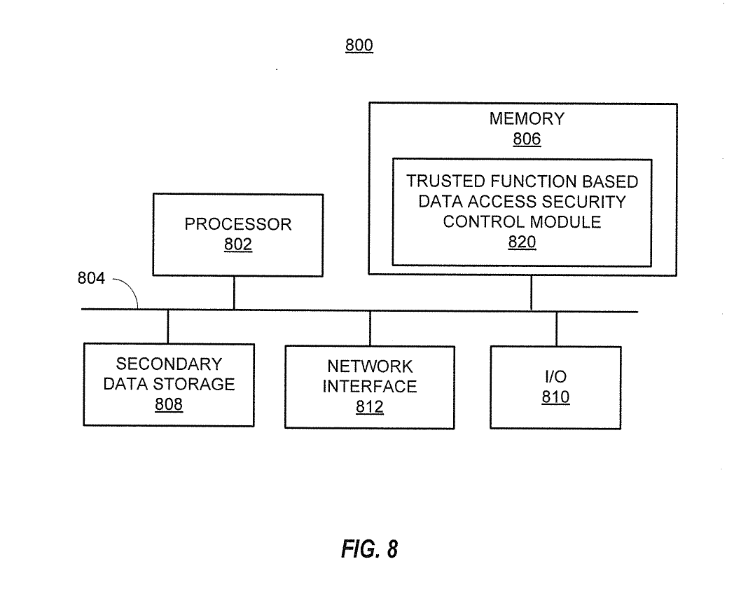

FIG. 8 shows a computer system 800 that may be used with the examples described herein. The computer system may represent a generic platform that includes components that may be in a server or another computer system. The computer system 800 may be used as a platform for the apparatus 100. The computer system 800 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 may include a processor 802 that may implement or execute machine readable instructions performing some or all of the methods, functions and other processes described herein. Commands and data from the processor 802 may be communicated over a communication bus 804. The computer system may also include a main memory 806, such as a random access memory (RAM), where the machine readable instructions and data for the processor 802 may reside during runtime, and a secondary data storage 808, which may be non-volatile and stores machine readable instructions and data. The memory and data storage are examples of computer readable mediums. The memory 806 may include a trusted function based data access security control module 820 including machine readable instructions residing in the memory 806 during runtime and executed by the processor 802. The trusted function based data access security control module 820 may include the modules of the apparatus 100 shown in FIG. 1.

The computer system 800 may include an I/O device 810, such as a keyboard, a mouse, a display, etc. The computer system may include a network interface 812 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A non-transitory computer readable medium having stored thereon machine readable instructions to provide trusted function based data access security control, the machine readable instructions, when executed, cause at least one processor to:
determine a restriction set by a first entity and related to at least one of access to and analysis related to data under the control of the first entity;
ascertain a trusted function including meta-data that describes a transformation of the data;
determine if the meta-data of the trusted function matches the restriction related to the at least one of access to and analysis related to the data;
in response to a determination that the meta-data of the trusted function matches the restriction, execute the trusted function to allow controlled access to is the data by a second entity; and
in response to a determination that the meta-data of the trusted function does not match the restriction, prevent execution of the trusted function to prevent the access to the data by the second entity.

2. The non-transitory computer readable medium of claim 1, wherein to ascertain a trusted function including meta-data that describes a transformation of the data, the machine readable instructions, when executed, further cause the at least one processor to:
receive the trusted function from a third entity that is trusted by the first and second entities.

3. The non-transitory computer readable medium of claim 1, wherein to ascertain a trusted function including meta-data that describes a transformation of the data, the machine readable instructions, when executed, further cause the at least one processor to:
receive the trusted function from the first entity, wherein the trusted function is based on the restriction set by the first entity.

4. The non-transitory computer readable medium of claim 1, wherein to ascertain a trusted function including meta-data that describes a transformation of the data, the machine readable instructions, when executed, further cause the at least one processor to:
select the trusted function from a set of trusted functions based on capabilities of the second entity for using the trusted function.

5. The non-transitory computer readable medium of claim 1, wherein to execute the trusted function to allow controlled access to the data by a second entity, the machine readable instructions, when executed, further cause the at least one processor to:
execute the trusted function in a trusted environment that is different from environments of the first and second entities.

6. The non-transitory computer readable medium of claim 1, wherein to execute the trusted function to allow controlled access to the data by a second entity, the machine readable instructions, when executed, further cause the at least one processor to:
execute the trusted function in a trusted environment that is the same as an environment of the first entity, the second entity, or both the first and second entities.

7. The non-transitory computer readable medium of claim 1, wherein to execute the trusted function to allow controlled access to the data by a second entity, the machine readable instructions, when executed, further cause the at least one processor to:
execute the trusted function to filter private information from the data.

8. The non-transitory computer readable medium of claim 1, wherein to execute the trusted function to allow controlled access to the data by a second entity, the machine readable instructions, when executed, further cause the at least one processor to:
execute the trusted function to apply statistical functions across predetermined data fields of the data.

9. The non-transitory computer readable medium of claim 1, wherein to execute the trusted function to allow controlled access to the data by a second entity, the machine readable instructions, when executed, further cause the at least one processor to:
execute the trusted function to restrict access to a statistically significant sample of the data.

10. A trusted function based data access security control apparatus comprising:
at least one processor; and
a memory storing machine readable instructions that when executed by the at least one processor cause the at least one processor to:
determine a restriction set by a first entity and related to at least one of access to and analysis related to data under the control of the first entity;
ascertain a trusted function including meta-data that describes a transformation of the data;
determine if the meta-data of the trusted function matches the restriction related to the at least one of access to and analysis related to the data;
in response to a determination that the meta-data of the trusted function matches the restriction:
execute the trusted function to allow controlled access to the data by a second entity, and
maintain a state across invocations of the trusted function; and
in response to a determination that the meta-data of the trusted function does not match the restriction, prevent execution of the trusted function to prevent the access to the data by the second entity.

11. The trusted function based data access security control apparatus of claim 10, wherein the transformation of the data includes at least one of a view of and the analysis related to the data.

12. The trusted function based data access security control apparatus of claim 10, wherein the trusted function includes at least one of a serial set of trusted functions and a programmatic combination of trusted functions including sampling and statistical analysis based trusted functions.

13. A method for trusted function based data access security control, the method comprising:
determining a restriction set by a first entity and related to at least one of access to and analysis related to data under the control of a first entity;
ascertaining a trusted function including meta-data that describes a transformation of the data, wherein the transformation of the data includes at least one of a view of and the analysis related to the data;
determining, by at least one processor, if the meta-data of the trusted function matches the restriction related to the at least one of access to and analysis related to the data;
in response to a determination that the meta-data of the trusted function matches the restriction, executing the trusted function to allow controlled access to the data by a second entity; and
in response to a determination that the meta-data of the trusted function does not match the restriction, preventing execution of the trusted function to prevent the access to the data by the second entity.
